(19) United States
(12) Patent Application Publication
(10) Pub. No.: US 2012/0097006 A1
(43) Pub. Date: Apr. 26, 2012

(54) Whirling cutting device

(75) Inventor: Hans-Joerg Braun, Hagen (DE)

(73) Assignee: REIKA GMBH & CO. KG, Hagen (DE)

(21) Appl. No.: 12/931,721

(22) Filed: Feb. 9, 2011

(30) Foreign Application Priority Data
Oct. 20, 2010 (EP) 10013793.4

(51) Int. Cl. B23D 45/08

(52) U.S. Cl. 83/646

(57) ABSTRACT

A device for chip-producing machining of work pieces in the form of pipes and rods, using the whirling method, has a whirling unit that has a housing, on which an accommodation for a whirling tool with teeth on the inside is mounted so as to rotate, and connected with an electromagnetic rotational direct drive. The drive has a ring-shaped stator attached to the housing and having an essentially C-shaped cross-section, and a rotor configured in the form of a ring-shaped hollow shaft having a T-shaped cross-section and provided with permanent magnets. The rotor is connected with the accommodation and is mounted on the outside of the C-shaped cross-section of the stator on its free shanks on both sides of the circumferential gap. The stator has a winding for generation of an electromagnetic field disposed between the free shanks and the closed rear wall of the C-shaped cross-section of the stator.

### CROSS REFERENCE TO RELATED APPLICATIONS

Applicant claims priority under 35 U.S.C. 119 of European Application No. EP 10013793.4 filed Oct. 20, 2010.

### BACKGROUND OF THE INVENTION

1. Field of the Invention

The invention relates to a device for chip-producing machining of work pieces in the form of pipes and rods, using the whirling method. In particular, the invention relates to a device comprising a whirling unit that has a housing, on which an accommodation for a whirling tool with teeth on the inside is mounted so as to rotate, and connected with a drive.

2. The Prior Art

The whirling method is a chip-removing method in which the tool circles around the work piece in the manner of a spiral whirl. The cutting depth is produced in a single work step, with one or more blades that revolve at a high cutting speed. In this connection, the inner mantle surface formed by the cutting tool rolls on the cylindrical outer mantle surface of the workpiece to be machined. The constantly circulating movement of the cutting tool is superimposed on this movement process.

The whirling method, which is known, for example, from European Patent No. EP 0 490 328 B1, has the advantage that a plurality of cutting tools, particularly cutting steels, can be disposed next to one another, engaging the work piece at the same time, in the case of a larger segment range. During whirling cutting, a whirling saw tool with teeth that lie on the inside—subsumed in the concept of “saw blade” hereinafter—is used. The cutting teeth of the saw blade can penetrate into the work piece tangentially. Because of the whirling method, the effective penetration radius of the saw blade only has to comprise the wall thickness of the work piece. If this is a solid material, the saw blade only has to penetrate to the center point of the solid material, since the other half of the work piece is cut off by the revolution of the saw blade. Such whirling cutting devices are referred to as “circular saw” hereinafter.

Use of the whirling method for chip-producing machining of work pieces in the form of pipes and rods reduces the machining time. The core part of the whirling device is the whirling unit, which has an accommodation for a whirling tool. This accommodation is mounted so as to rotate and is driven by a drive motor. With regard to coupling of the drive motor with the accommodation, two embodiments, in particular, are used. For one thing, it is known to dispose the drive motor parallel to the axis of rotation of the accommodation, and to couple it with the accommodation by way of a belt drive. For this purpose, the electric motor must be dimensioned relatively large, so that the high torques and high speeds of rotation required for the whirling process can be made available. The drive motor is frequently disposed on the side of the housing of the whirling unit, so that the whirling unit takes up a significant construction space. This is disadvantageous, particularly with regard to the pivoting angle of the whirling unit, which is frequently mounted at a slant, since the angle is restricted when the motor is disposed on the side. Furthermore, the belt drive is subject to mechanical wear, and this is accompanied by a loss in power with regard to the torque actually transferred. Furthermore, only unsatisfactorily smooth running can be achieved with the known belt drive.

Furthermore, it is known to dispose the drive motor so that it stands perpendicular to the axis of rotation of the accommodation with its drive shaft, and to couple it with the accommodation by way of a translation gear mechanism or conical gear mechanism. Here again, the drive motor must be dimensioned to be large, so that the required torques and speeds of rotation can be made available. This solution also requires significant construction space and furthermore proves to be very complicated with regard to the translation gear mechanism or conical gear mechanism to be used.

### SUMMARY OF THE INVENTION

It is therefore an object of the invention to provide a device for chip-producing machining of work pieces in the form of pipes and rods, in which the construction size of the whirling unit is minimized, in which power losses with regard to the actual torque transferred are avoided, and in which great air rest can be achieved.

This object is accomplished according to the invention, by a whirling cutting device having an electromagnetic rotational direct drive comprising a ring-shaped stator attached to the housing of the device and having an essentially C-shaped cross-section, and a rotor configured in the form of a ring-shaped hollow shaft having a T-shaped cross-section and provided with permanent magnets. The rotor is connected with the accommodation and is mounted on the C-shaped cross-section of the stator, on the outside, on its free shanks, on both sides of the circumferential gap. The stator is provided with a winding for generation of an electromagnetic field, which winding is disposed between the free shanks and the closed rear wall of the C-shaped cross-section of the stator, which wall lies opposite these shanks.

With the invention, a device for chip-producing machining of work pieces in the form of pipes and rods, using the whirling method, is created, in which the construction space of the whirling unit is minimized, and in which a power loss with regard to the actual torque transferred is avoided. By using an electromagnetic rotational direct drive, integration of the drive directly into the whirling unit is achieved. This direct drive acts directly together with the accommodation; transfer media such as toothed belts are not required. By forming the stator as a ring having a C-shaped cross-section, firmly affixed to the housing, and the configuration of the rotor as a hollow shaft having a T-shaped cross-section, which is mounted onto the C-shaped cross-section of the stator on the outside, on its free shanks, on both sides of the circumferential gap, a very compact structure with a very small number of components is made possible. The windings of the stator are disposed over a large diameter within the C-shaped cross-section of the stator, between the free shanks and the rear wall that lies opposite them. This large diameter makes a relatively large number of poles possible, while simultaneously maintaining the ability of the drive to withstand thermal stress. Since no mechanical transmission elements are present, there is great mechanical resistance to overload, thereby establishing great operational reliability. Because the bearings are disposed outside of the windings of the stator, there is only a slight heat transfer to the bearings.

In a further development of the invention, at least one channel for passing coolant through is disposed on the stator. In this way, better cooling of the winding is achieved, thereby making it possible to achieve better ability of the drive to withstand thermal stress, even in the case of a high-pole arrangement.

In an embodiment of the invention, there is at least one groove on the side wall of the C-shaped cross-section of the stator that faces the tool accommodation. A guide crosspiece formed onto the accommodation engages this groove. In this way, good guidance of the accommodation is brought about.

In a further embodiment of the invention, the circumferential cross-piece of the T-shaped cross-section of the rotor, which crosspiece projects radially to the outside, engages into the circumferential gap of the C-shaped cross-section of the stator. In this way, a low construction depth is achieved. Preferably, the circumferential crosspiece of the rotor engages into the gap of the stator in such a manner that its head surface aligns with the inside surfaces of the free shanks of the C-shaped cross-section of the stator.

In a further embodiment of the invention, the rotor is connected, on its side that lies opposite the tool accommodation, with a flange that is rotatably connected with the stator. In this way, good accessibility of the rotor is brought about.

In another embodiment of the invention, a bearing seat is formed between stator, rotor, and tool accommodation or flange, on both sides of the crosspiece of the T-shaped cross-section of the rotor, which seat completely surrounds the bearing. In this way, penetration of metal chips into the bearings is effectively prevented. Furthermore, the bearings can be provided with permanent lubrication, thereby making it possible to achieve maintenance-free mounting.

In a further development of the invention, the accommodation of the whirling unit comprises indexing pins that correspond to indexing bores present on the whirling tool. In this way, accommodation of the whirling tool in the accommodation, in the correct position, is made possible.

In an embodiment of the invention, the housing of the whirling unit has an outer wall configured in the manner of a barrel section. In this way, pivoting mounting of the whirling unit within the machining device is made possible.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of a circular saw in a view from the rear;

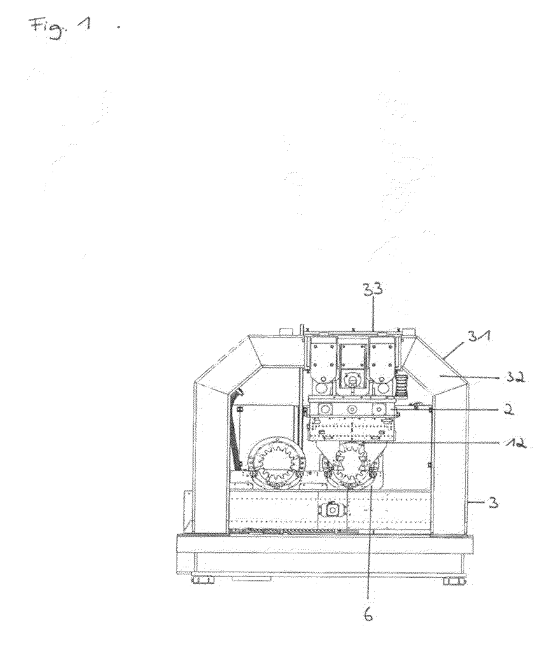

FIG. 2 shows a schematic representation of the whirling unit with electromagnetic rotational direct drive of the circular saw from FIG. 1; and

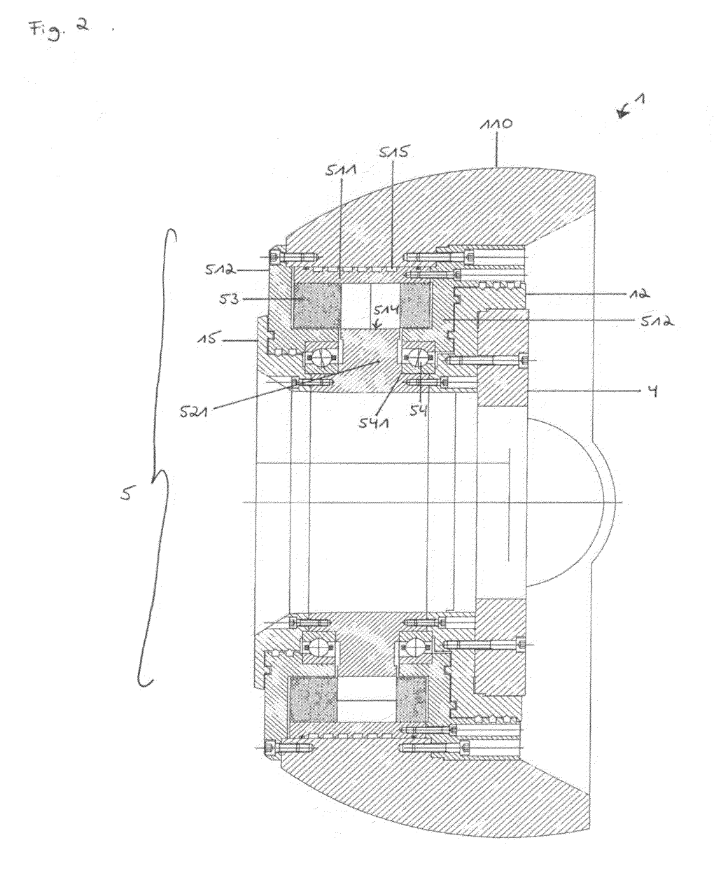

FIG. 3 shows a schematic representation of the whirling unit according to FIG. 2, disposed in an accommodation of the circular saw according to FIG. 1, so as to pivot.

### DETAILED DESCRIPTION OF THE PREFERRED EMBODIMENT

Referring now in detail to the drawings, the whirling device selected as the exemplary embodiment is a whirling cutting device, referred to hereinafter as a circular saw. It comprises a whirling unit 1 disposed in a housing 11, having a work piece feed as well as a pick-up 2, which are disposed in a frame system 3. In this connection, frame system 3 is essentially formed from two portals 31, 32 disposed parallel to one another, which are connected with one another at the head side by way of a connection beam 33. In this connection, whirling unit 1 is attached to unit portal 31; support portal 32 serves as the bearing for connection beam 33. A rail is attached to connection beam 33, on which rail pick-up 2 is displaceably disposed. In the exemplary embodiment, the circular saw has an integrated tool change system 6.

Whirling unit 1 comprises a tool accommodation 12 for accommodating a saw blade 4. Tool accommodation 12 is configured essentially in funnel shape, thereby improving the removal of chips. Surrounding its circular opening, a contact flange for accurate-fit contact of a saw blade 4 is disposed in tool accommodation 12. For a defined position of saw blade 4 in tool accommodation 12, the contact flange is provided with an indexing pin—not shown—that can be introduced into an indexing bore 42 made in the blade carrier ring 41.

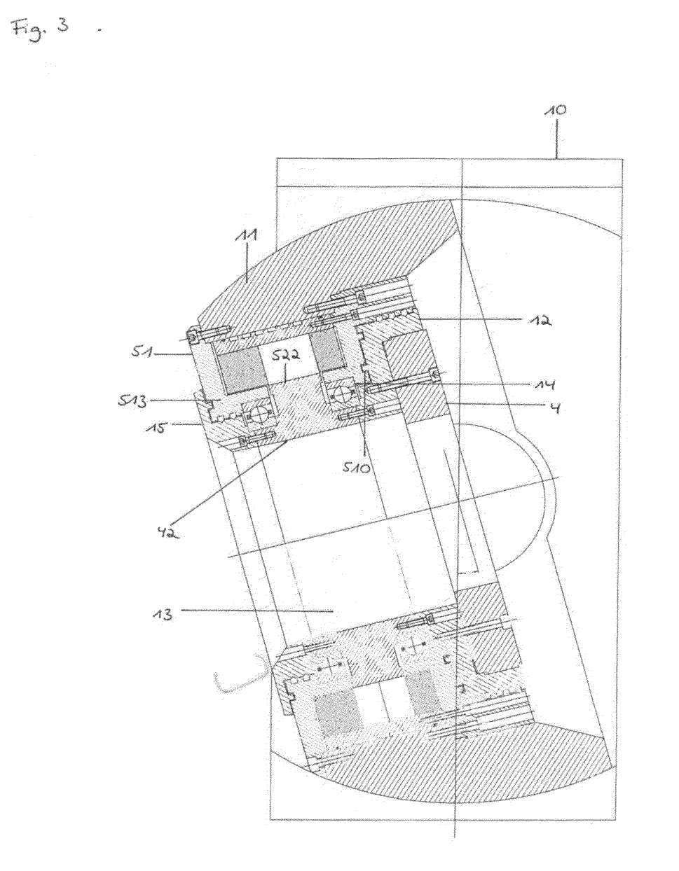

Tool accommodation 12 is connected with an electromagnetic rotational direct drive 5. As shown in FIG. 3, direct drive 5 is essentially formed by a ring-shaped stator 51 affixed to housing 11 of the whirling unit 1, which stator has an essentially C-shaped cross-section, and a rotor 52 that is formed in the form of a hollow shaft having a T-shaped cross-section, the circumferential crosspiece 521 of which projects to the outside and is provided with permanent magnets 522. In this embodiment, tool accommodation 12 is screwed onto rotor 52. Tool accommodation 12 is connected with stator 51, so as to rotate, by way of rotor 52 and bearings 54. A closed bearing seat is formed between free shanks 513 of the C profile of stator 51, the hollow shaft of rotor 52, and tool accommodation 12, thereby preventing penetration of metal chips into bearing 54. On its side that lies opposite tool accommodation 12, rotor 52 is screwed onto a flange 15, which is connected with stator 51 so as to rotate. Flange 15 in turn is disposed in such a manner that in the same way, a closed bearing seat 514 for bearing 54 that lies against flange 15 is formed. Tool accommodation 12 and flange 15 are connected with stator 51 by means of grooves 510 and guide crosspieces 14, via gear teeth.

Windings 53 are disposed within the C-shaped cross-section of stator 51, between its free shanks 513 and its side wall 512 that lies opposite the free shanks 513. Windings 53 are shown only schematically in the figures. They are configured in such a manner that only a narrow air gap is formed between windings 53 and crosspiece 521 of rotor 52 that is provided with permanent magnet 522. In this connection, crosspiece 521 of rotor 52 engages into gap 514 formed between free shanks 513 of the C-shaped cross-section of stator 51, in such a manner that the head surface of crosspiece 521 essentially aligns with the inner surfaces of free shanks 513 of the C-shaped cross-section of stator 51. For better heat removal, cooling channels 515 are furthermore provided on stator 51.

In this embodiment, housing 11 of whirling unit 1 is provided with an outer wall configured in the manner of a barrel section, and mounted in an accommodation 10 of the circular saw so as to pivot. In this connection, accommodation 10 has a barrel-shaped inside contour that corresponds to the outside contour of housing 11 of the whirling unit, so that good radial support of the whirling unit is guaranteed in every pivoting position of the whirling unit.

The electromagnetic rotational direct drive 5 that is used is indicated only with its essential components in the present case. Details of the configuration of such direct drives are sufficiently known to a person skilled in the art. The particular advantage of the arrangement of the direct drive according to the invention particularly results from the simpler mechanical structure. By eliminating the mechanical transmission elements used for power transformation, this direct drive is free of play. System variables such as current, power or torque, and speed or speed of rotation can be determined directly and included in a regulation concept. This not only improves the positioning accuracy but also simplifies the regulation of this drive. Another advantage that results from the elimination of mechanical transmission elements is the freedom from maintenance. This is achieved, among other things, by the special closed installation position of the bearings 54, which are furthermore disposed at a distance from the tool accommodation, thereby preventing penetration of chips into the bearings 54. Additional measures, such as providing blocking air to protect the bearings, for example, are therefore made unnecessary.

The circular saw described above is only an example of a device for chip-producing machining; of course, the present invention is not restricted to whirling cutting devices. Instead, the invention extends to cover all devices with which chip-producing machining of work pieces in the form of pipes and rods by means of whirling methods can be achieved. These also include devices for thread whirling, for example.

Accordingly, while only a few embodiments of the present invention have been shown and described, it is obvious that many changes and modifications may be made thereunto without departing from the spirit and scope of the invention.

What is claimed is:

1. A device for chip-producing machining of work pieces in the form of pipes and rods, using the whirling method, comprising:
a whirling unit having a housing;
an accommodation for a whirling tool with teeth on the inside, said accommodation being rotatably mounted on the whirling unit; and
an electromagnetic rotational direct drive, comprising:
a ring-shaped stator attached to the housing and having an essentially C-shaped cross-section with free shanks and a circumferential gap, and
a rotor configured in the form of a ring-shaped hollow shaft having a T-shaped cross-section and provided with permanent magnets, said rotor being connected with the accommodation and mounted on an outside of the C-shaped cross-section of the stator on the free shanks, on both sides of the circumferential gap;
wherein the stator is provided with a winding for generation of an electromagnetic field, said winding being disposed between the free shanks and a closed rear wall of the C-shaped cross-section of the stator, the wall lying opposite the shanks.

2. The device according to claim 1, wherein there is at least one groove introduced on a side wall of the C-shaped cross-section of the stator, said side wall facing the tool accommodation and wherein a guide crosspiece formed onto the accommodation engages into said groove.

3. The device according to claim 2, wherein a circumferential crosspiece of the T-shaped cross-section of the rotor, which projects radially to the outside, engages into the circumferential gap of the C-shaped cross-section of the stator.

4. The device according to claim 3, wherein the circumferential crosspiece of the rotor engages into the gap of the stator so that a head surface of the rotor aligns with inner surfaces of the free shanks of the C-shaped cross-section of the stator.

5. The device according to claim 1, wherein the rotor is connected to a flange on a side of the rotor that lies opposite the tool accommodation, said flange being rotatably connected with the stator.

6. The device according to claim 5, wherein a bearing seat is formed between the stator, the rotor and the accommodation or flange, on both sides of the crosspiece of the T-shaped cross-section of the rotor, said bearing seat completely surrounding a bearing accommodated in the bearing seat.

7. The device according to claim 1, wherein the stator has at least one channel for passing coolant through.

8. The device according to claim 1, wherein the housing of the whirling unit has an outside wall configured in the manner of a barrel section.
